(19) United States
(12) Patent Application Publication
(10) Pub. No.: US 2026/0287020 A1
(43) Pub. Date: Sep. 24, 2026

(54) BEARING SYSTEM INCLUDING A GROUNDING BRUSH ASSEMBLY AND ASSOCIATED ASSEMBLY

(71) Applicants: AKTIEBOLAGET SKF, GOTEBORG (SE); SKF Aerospace France S.A.S, Perrigny (FR)

(72) Inventors: Benoit ARNAULT, Saint-Cyr-sur-Loire (FR); Franck GERVAIS, Bourg de Péage (FR)

(21) Appl. No.: 19/564,514

(22) Filed: Mar. 12, 2026

(30) Foreign Application Priority Data
Mar. 21, 2025 (FR) 2502892FR

(51) Int. Cl. F16C 41/00; H02K 11/40

(52) U.S. Cl. CPC F16C 41/002; H02K 11/40; F16C 2380/26

(57) ABSTRACT

A bearing system includes a bearing provided with an inner ring and an outer ring and a grounding brush assembly. The grounding brush assembly includes a brush offset axially toward the outside relative to the inner ring of the bearing and provided with a plurality of conductive fibers and a support inside of which the conductive fibers are mounted. The grounding brush assembly also includes a brush mounting plate secured to the support of the brush and having a mounting portion with at least one retaining arranged inside a groove formed in a bore of the outer ring of the bearing.

### CROSS-REFERENCE

This application claims priority to French patent application no. 2502892 filed on Mar. 21, 2025, the contents of which are fully incorporated herein by reference.

### BACKGROUND OF THE INVENTION

The present invention relates to the general field of grounding devices for controlling the shaft current generated in electric motors or machines and, more particularly to grounding brush assemblies.

In an electric motor or machine, at least one rolling bearing is mounted between the housing of the electric motor or machine and the rotating shaft in order to support this shaft.

During operation when the shaft is in rotation, a difference in electrical potential can arise between the shaft and the housing of the electric motor or machine, which generates an electric current between the inner ring of the rolling bearing which is secured to the shaft and the outer ring which is secured to the housing.

The electric current passing through the components of the rolling bearing can damage these components, in particular the rolling elements and the raceways formed on the inner and outer rings. The electrical discharges can also generate vibrations.

In order to remedy these drawbacks, it is known to earth or ground the rotating shaft by using a grounding brush or grounding brush, comprising conductive fibers. The grounding brush is generally mounted in the bore of the housing of the electric motor such that the free ends of the fibers are in radial contact with the outer surface of the rotating shaft.

Due to the conductivity of the fibers, the brush is held at the same electrical potential as the housing of the electric motor. The inner and outer rings of the rolling bearing are also at the same electrical potential, which reduces, or even eliminates, the problematic electrical discharges through the rolling bearing.

A grounding brush assembly is disclosed in the document US Patent Publication No. 2021/0021180 A1 , which includes a grounding brush provided with a plurality of conductive fibers, a support inside which the conductive fibers are mounted, and an annular mounting plate comprising a plurality of radial and axial retaining tabs of the support and an annular outer flange radially surrounding the brush and the tabs.

It is also possible to provide the outer surface of the outer ring of the rolling bearing with the grounding brush assembly.

However, with such a solution, the mounting of this assembly between the housing and the rotating shaft of the electric motor can be difficult to implement.

The present invention aims to remedy this drawback.

### SUMMARY OF THE INVENTION

The present invention relates to a bearing system comprising a bearing provided with a first ring and a second ring capable of rotating relative to one another.

The system also comprises a grounding brush assembly comprising a brush which is offset axially toward the outside relative to the inner ring of the bearing and which is provided with a plurality of conductive fibers and a support inside which the conductive fibers are mounted. The conductive fibers preferably extend so as to protrude radially toward the inside relative to the support.

The grounding brush assembly also comprises a brush mounting plate secured to the support of the brush. The brush mounting plate comprises a mounting portion arranged inside a groove formed in a bore of the outer ring of the bearing. The groove is provided with first and second axially opposing lateral walls and an internal edge extending between the second lateral wall and a front face of the outer ring.

The mounting portion of the mounting plate comprises at least one retaining tab axially in abutment on one side against the first lateral wall of the groove and on the other side against the second lateral wall, the free end of the tab being offset radially toward the outside relative to the internal edge of the groove to provide the axial retention of the mounting plate relative to the outer ring.

This design makes it possible to facilitate the mounting of the system inside the housing of the associated electric motor to the extent that the mounting portion of the mounting plate is fixed in the groove of the bore of the outer ring of the bearing.

The retaining tab of the mounting portion of the mounting plate provides a fixing of the assembly relative to the outer ring of the bearing in a simple and economic manner.

In one embodiment, the retaining tab of the mounting portion of the mounting plate is flat.

Advantageously, the retaining tab of the mounting portion of the mounting plate extends obliquely toward the outside. The axial retention of the retaining tab is increased by the bracing effect.

In one embodiment, the mounting portion of the mounting plate also comprises at least one flange axially in abutment against the first lateral wall of the groove, the free end of the flange being offset radially toward the inside relative to the internal edge of the groove or in contact with the internal edge, the retaining tab being offset circumferentially relative to the flange.

The circumferential dimension of the flange can be greater than the circumferential dimension of the tab.

In one embodiment, the flange of the mounting portion of the mounting plate remains at a distance from the second lateral wall of the groove.

In one particular embodiment, the mounting portion of the mounting plate comprises at least two radial flanges axially in abutment against the first lateral wall of the groove and at least two retaining tabs, each of the retaining tabs being located circumferentially between the radial flanges.

The mounting plate is preferably produced in a single piece.

The invention also relates to an electric motor comprising a housing, a shaft and at least one bearing system according to any one of the above-described embodiments, mounted radially between the housing and the shaft.

The invention further relates to an assembly method of a bearing system according to any one of the embodiments described above, comprising the following steps:
before mounting the grounding brush assembly on the bearing, the retaining tab of the mounting portion of the mounting plate is folded axially on the side opposing the brush such that the outer diameter of the mounting plate defined by the tab is less than the inner diameter of the internal edge of the groove of the outer ring of the bearing;
the grounding brush assembly is axially displaced relative to the bearing so as to bring the deformed retaining tab of the mounting portion of the mounting plate axially into abutment against the first lateral wall of the groove of the outer ring of the bearing, the free end of the retaining tab remaining radially at a distance from the internal edge of the groove during this relative displacement; and
then the retaining tab is deformed so as to press it against the first lateral wall of the groove of the outer ring of the bearing and so that the free end of the retaining tab is offset radially toward the outside relative to the internal edge of the groove.

### BRIEF DESCRIPTION OF THE SEVERAL VIEWS OF THE DRAWINGS

The present invention will be understood more clearly by studying the detailed description of an embodiment provided by way of non-limiting example and illustrated by the accompanying drawings, in which:

FIG. 1 is a perspective view of a bearing system according to an exemplary embodiment of the invention;

FIG. 2 is a front view of the bearing system of FIG. 1;

FIG. 3 is a half sectional view along the axis III-III of FIG. 2;

FIG. 4 is a half sectional view along the axis IV-IV of FIG. 2;

FIG. 5 is a detailed view of FIG. 4;

FIG. 6 is a sectional view along the axis VI-VI of FIG. 4;

FIG. 7 is a front perspective view of a grounding brush assembly of the bearing system of FIG. 1;

FIG. 8 is a rear perspective view of a grounding brush assembly of the bearing system of FIG. 1;

FIG. 9 is a half sectional view along the axis III-III of FIG. 2 during the assembly of the grounding brush assembly with the bearing of the bearing system;

FIG. 10 is a half sectional view along the axis IV-IV of FIG. 2 during the assembly of the grounding brush assembly with the bearing of the bearing system; and

FIG. 11 is a half sectional view illustrating schematically the mounting of the bearing system of FIG. 1 inside a housing of an electric machine.

### DETAILED DESCRIPTION OF THE INVENTION

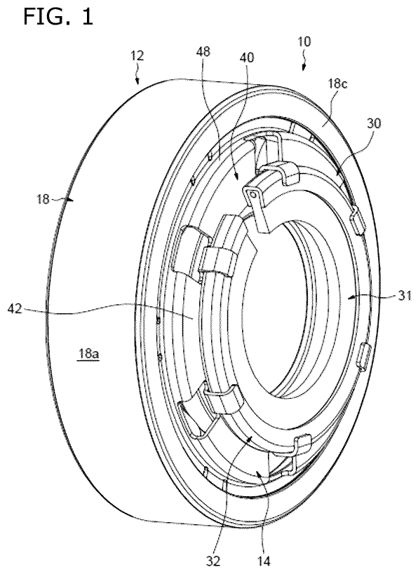

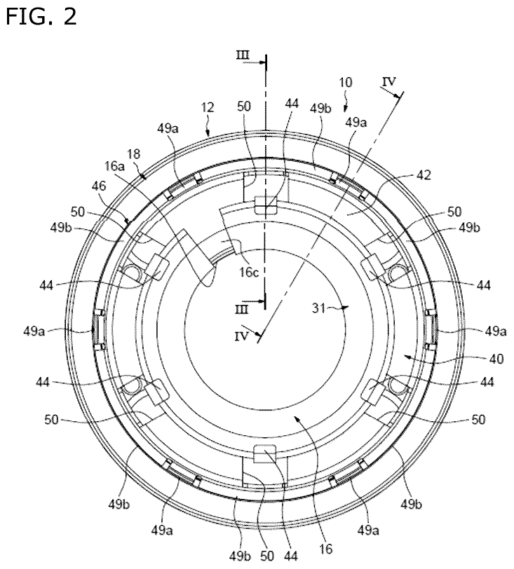

The bearing system illustrated in FIGS. 1 to 4 and referenced by 10 in its entirety is designed to be mounted radially between a housing and a rotating shaft of the electric motor or machine.

The bearing system 10 comprises a bearing 12 and a grounding brush assembly 14 mounted on the bearing 12. The bearing 12 is provided with an inner ring 16 and a second outer ring 18 which are capable of rotating relative to one another about the axis (not shown) of the bearing 12. The inner 16 and outer 18 rings of the bearing 12 are concentric and extend axially along the axis of the bearing 12. The inner 16 and outer 18 rings are produced from steel. The rings are of the solid type.

In the illustrated exemplary embodiment, the bearing 12 also comprises a row of rolling elements 20, preferably balls but may alternatively be cylindrical rollers, tapered rollers, needles or any other type of rolling element. The rolling elements 20 are interposed radially between the inner 16 and outer 18 rings. The bearing 12 also comprises a cage 22 for maintaining the regular circumferential spacing of the rolling elements 20.

The inner ring 16 includes a cylindrical bore 16a, an axial cylindrical outer surface 16b radially opposing the bore 16a, and first and second radial opposing front faces 16c, 16d axially delimiting the bore 16a and the outer surface 16b. The bore 16a and the outer surface 16b delimit the radial thickness of the inner ring 16. The front faces 16c, 16d delimit the axial length of the inner ring 16.

The outer ring 18 includes an axial cylindrical outer surface 18a, a cylindrical bore 18b radially opposing the outer surface 18a and first and second radially opposing front faces 18c, 18d axially delimiting the bore 18b and the outer surface 18a. The outer surface 18a and the bore 18b delimit the radial thickness of the outer ring 18. The faces 18c, 18d delimit the axial length of the outer ring 18.

The outer ring 18 also comprises first and second annular grooves 24, 26 formed on the bore 18b and extending radially toward the outside. Each groove 24, 26 is oriented radially on the side of the inner ring 16.

The grooves 24, 26 are arranged axially on either side of the row of rolling elements 20. The groove 24 is located axially in the vicinity of the front face 18c of the outer ring 18 and the groove 26 is located axially in the vicinity of the front face 18d. The grooves 24, 26 are symmetrical to one another relative to the radial median plane of the bearing system. Alternatively, the outer ring 18 could simply comprise a single groove, e.g., the groove 24.

As will be described in more detail below, the grounding brush assembly 14 is fixed in the groove 24 of the outer ring 18 of the bearing 12. The assembly 14 has an annular overall shape. The assembly 14 comprises a grounding brush 30 and a brush mounting plate 40 configured to center radially the brush 30. The mounting plate 40 is fixed in the groove 24 of the outer ring 18 of the bearing 12.

The brush 30 is offset axially toward the outside relative to the inner ring 16 of the bearing 12. In other words, the brush 30 is spaced apart axially from the inner ring 16 of the bearing 12. The brush 30 is arranged outside the bearing 12.

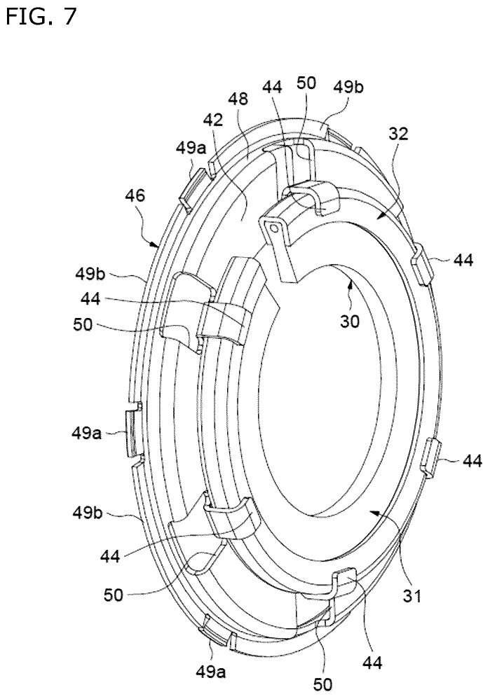

The brush 30 comprises a plurality of individual conductive fibers 31 designed to pass around the rotating shaft of the motor; i.e., the conductive fibers 31 are spaced circumferentially about the motor shaft. The conductive fibers 31 can be produced from carbon, from stainless steel, from conductive plastics, such as acrylic fibers, or from nylon. In FIGS. 1, 2, 7 and 8, the conductive fibers 31 are shown schematically.

The brush 30 also comprises a holding member or support 32 inside which the conductive fibers 31 are mounted or disposed. The conductive fibers 31 extend so as to protrude radially toward the inside relative to the support 32.

In the illustrated exemplary embodiment, the support 32 is in the form of an open ring. The support 32 is produced from rigid material. The support 32 can be produced by cutting and stamping. The support 32 is produced from electrically conductive material, such as for example from aluminum, stainless steel, bronze, copper or other material. Alternatively, the support 32 can be produced from electrically non-conductive material with a conductive coating or conductive paint.

The brush 30 also preferably comprises a ring 33 about which the conductive fibers 31 are arranged inside the support 32. The ring 33 fulfils the function of supporting and retaining the conductive fibers 31. The ring 33 is mounted inside the support 32.

The support 32 of the brush 30 comprises an axial mounting portion 34 and two opposing lateral flanks 36, 38 extending from the mounting portion 34 toward the inside and axially gripping the conductive fibers 31. The conductive fibers 31 axially bear on either side against the lateral flanks 36, 38. The conductive fibers 31 radially bear against the mounting portion 34. The conductive fibers 31 extend so as to protrude radially toward the inside relative to the lateral flanks 36, 38 of the support 32.

The mounting portion 34 and the two lateral flanks 36, 38 delimit a channel which is radially open on the inside and inside which the conductive fibers 31 are partially located.

The lateral flank 36 extends one end of the mounting portion 34 and the lateral flank 38 extends the opposing end thereof. Preferably, the lateral flanks 36, 38 extend obliquely toward the inside from the mounting portion 34. The lateral flanks 36, 38 are symmetrical to one another relative to a radial median plane of the support 32. Alternatively, merely one of the lateral flanks 36, 38 could extend obliquely toward the inside. In a further variant, the two lateral flanks 36, 38 could extend substantially or entirely radially. The mounting portion 34 extends axially here. Alternatively, the mounting portion 34 could extend obliquely.

The brush 30 is in the form of an open ring. This permits or enables the brush 30 to be adapted to different diameters of the shaft of the motor. Generally the ends of the brush 30 are not fixed to one another, but as a variant, these ends of the brush 30 may be fixed to one another.

The conductive fibers 31 have distal free ends which are designed to come into radial contact with the outer surface of the rotating shaft of the motor. The free ends of the conductive fibers 31 define the inner diameter of the conductive fibers 31 and more generally the inner diameter of the brush 30.

In the illustrated exemplary embodiment, the free ends of the conductive fibers 31 are offset radially toward the inside relative to the bore 16a of the inner ring 16 of the bearing 12. In other words, the free ends of the conductive fibers 31 protrude radially relative to the bore 16a of the inner ring 16. Alternatively, the free ends of the conductive fibers 31 could be radially in contact with the bore 16a. In a further alternative, the free ends of the conductive fibers 31 could be radially set back or offset relative to the bore 16a in the case where the bearing system also comprises a sleeve mounted in the bore 16a of the inner ring 16.

The mounting plate 40 of the grounding brush assembly 14 comprises an annular radial portion 42 and a plurality of axial and radial retaining tabs 44 of the brush 30 extending from the radial portion 42.

The mounting plate 40 also comprises a mounting portion 46 arranged in the groove 24 of the outer ring 18 of the bearing 12 and a connecting portion 48 connecting the mounting portion 46 to the radial portion 42.

The radial portion 42 of the mounting plate 40 is axially in abutment against the support 32 of the brush 30. More specifically, the mounting portion 42 is axially in abutment against the lateral flank 36 of the support 32. The radial portion 42 is offset axially toward the outside relative to the inner ring 16 of the bearing 12. The radial portion 42 remains axially at a distance from the front face 16c of the inner ring 16. The support 32 of the brush 30 is axially in abutment against the radial portion 42 axially on the side opposing the inner ring 16. Alternatively, according to the design of the mounting plate 40, the support 32 of the brush 30 can be axially in abutment against the radial portion 42 axially on the side of the inner ring 16. In this case, the support 32 is arranged axially between the radial portion 42 of the mounting plate 40 and the face 16c of the inner ring 16 by remaining axially spaced apart from this face 16c.

The tabs 44 of the mounting plate are spaced apart from one another in the circumferential direction, in this case in a regular or even manner. Alternatively, it could be possible to provide an irregular circumferential spacing or staggered. In the illustrated exemplary embodiment, the tabs 44 are six in number. Alternatively, it is possible to provide a larger or smaller number of tabs 44. It is possible to provide two tabs 44 or at least four tabs 44. Preferably, the number of tabs 44 is at least equal to two.

Each tab 44 extends so as to protrude axially relative to the radial portion 42. Each tab 44 locally surrounds the support 32 of the brush 30 radially and is in radial contact with the mounting portion 34 of the support 32. The support 32 is held axially in abutment against the radial portion 42 of the mounting plate 40 by the tabs 44. The tabs 44 permit the grounding brush 30 to be retained axially and radially. The lateral flank 36 of the support 32 is in abutment against the radial portion 42 of the mounting plate 40 and the lateral flank 38 is in abutment against the tabs 44. The tabs 44 are preferably identical to one another.

Each tab 44 is provided with an axial portion extending axially from the radial portion 42, locally surrounding the support 32 radially, and is in radial contact therewith and a portion folded radially toward the inside which is provided at the free end of the axial portion. The folded portion of each tab 44 makes it possible to axially retain the support 32 of the grounding brush 30. The folded portion of each tab 44 is in axial contact with the lateral flank 38 of the support 32.

The connecting portion 48 of the mounting plate 40 is annular and extends axially. The connecting portion 48 extends axially between the outer edge of a large diameter of the radial portion 42 and the inner edge of small diameter of the mounting portion 46. The mounting portion 46 is offset radially toward the outside relative to the tabs 44 and offset axially toward the inside of the bearing 12 relative to the tabs 44.

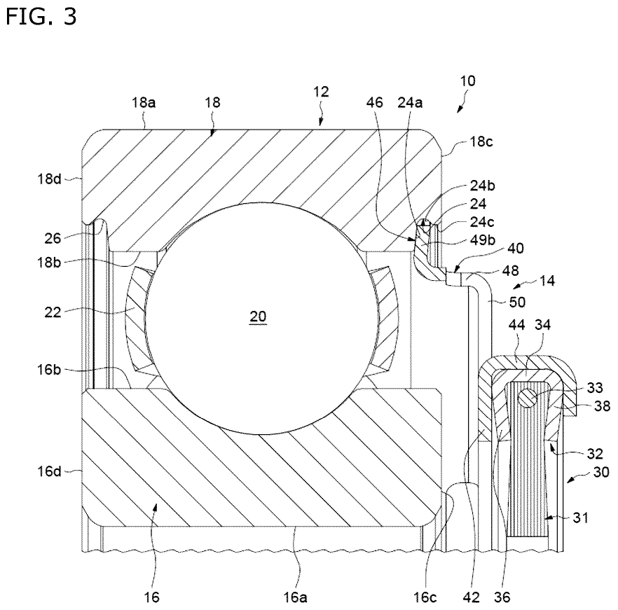

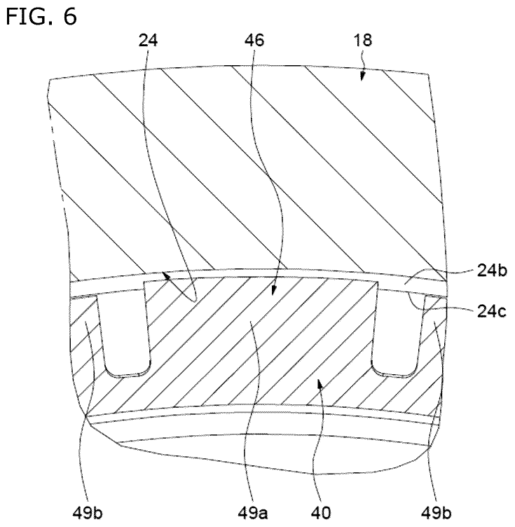

As illustrated more clearly in FIGS. 3 to 8, the mounting portion 46 of the mounting plate 40 comprises axial retaining tabs 49a and flanges 49b. The tabs 49a are spaced apart from each other in the circumferential direction, preferably in a regular or even manner. Alternatively, the tabs 49a may be spaced in an irregular circumferential spacing or staggered. In the illustrated exemplary embodiment, the tabs 49a are six in number. Alternatively, it is possible to provide a greater or lesser number of tabs 49a. For example, it is possible to provide a single tab 49a or at least two tabs 49a or four tabs 49a. Preferably, the number of tabs 49a is at least equal to two. Preferably, the tabs 49a are identical to one another or identically formed. Alternatively, the tabs 49a could have different circumferential dimensions.

Each tab 49a is located circumferentially between two successive flanges 49b of the mounting portion 46. The flanges 49b are regularly or evenly spaced apart from one another in the circumferential direction. Alternatively, it could be possible to provide an irregular circumferential spacing of the flanges 49b. In the illustrated exemplary embodiment, there are as many tabs 49a as flanges 49b. Alternatively, the number of tabs 49a and flanges 49b could be different. Preferably, the flanges 49b are identical to one another or identically formed. Alternatively, the flanges 49b may have different circumferential dimensions.

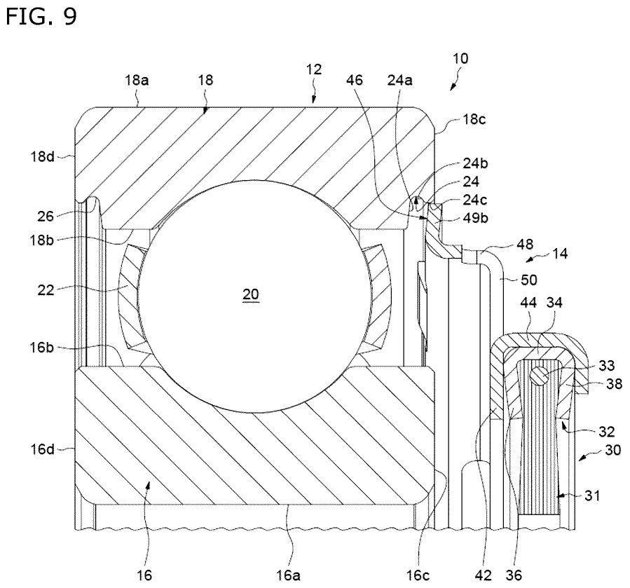

The circumferential dimension of the flanges 49b is greater than the circumferential dimension of the tabs 49a. As illustrated in FIGS. 3, 4, 9, 10 and 11, the retaining tabs 49a are flat.

Each tab 49a extends so as to protrude radially toward the outside, or radially outwardly, from the edge of the connecting portion 48 of the mounting plate 40 which axially opposes the radial portion 42. Each tab 49a is arranged in the groove 24 of the outer ring 18 of the bearing 12.

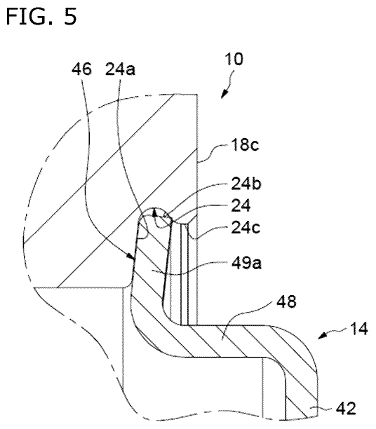

As illustrated more clearly in FIG. 5, the groove 24 is provided with first and second lateral walls 24a, 24b, respectively, or axially opposing flanks. The first and second lateral walls 24a, 24b are connected by a base (not referenced) oriented radially toward the inside. The base is concave in this case. Alternatively, the base could have different profiles, for example flat. In a further variant, the groove 24 could be without a base, in which case the lateral walls 24a, 24b are connected to one another.

The groove 24 is also provided with an internal edge 24c which extends axially from the end of an inner, small diameter of the second lateral wall 24b and which is connected to the front face 18c of the outer ring 18. The edge 24c extends between the second lateral wall 24b and the front face 18c and connects the second lateral wall 24b and the front face 18c. The edge 24c is offset radially toward the inside relative to the base 24c. The groove 24 is of stepped shape. The second lateral wall 24b has a reduced radial dimension relative to the first lateral wall 24a.

Each tab 49a is flat and extends obliquely toward the outside. Each tab 49a is axially in abutment on one side against the first lateral wall 24a of the groove 24 and on the other side against the second lateral wall 24b. Each tab 49a is axially in abutment against the majority of the first lateral wall 24a of the groove 24. The free end of each tab 49a is axially in abutment against the second lateral wall 24b. The free end of each tab 49a is offset radially toward the outside relative to the internal edge 24c of the groove 24. Each tab 49a provides the axial retention of the mounting plate 40 relative to the outer ring 18. The axial retention of the mounting plate 40 relative to the outer ring 18 is provided by diametric interference between the tabs 49a and the second lateral wall 24b of the groove 24. The outer diameter of the tabs 49a is greater than the inner diameter of the internal edge 24c of the groove 24. The outer diameter of each one of the tabs 49a of the mounting portion 46 collectively defines the outer diameter of the mounting plate 40.

Each flange 49b extends so as to protrude radially toward the outside from the edge of the connecting portion 48 of the mounting plate 40 which axially opposes the radial portion 42. Each flange 49b is arranged in the groove 24 of the outer ring 18 of the bearing 12. Each flange 49b is flat and extends obliquely toward the outside. Each flange 49b is axially in abutment against the first lateral wall 24a of the groove 24. There is no axial contact between the flanges 49b and the second lateral wall 24b of the groove 24. In other words, the flanges 49b remain at a distance from the second lateral wall 24b of the groove 24. Each flange 49b is axially in abutment against the majority of the first lateral wall 24a of the groove 24. The free end of each flange 49b is offset radially toward the inside relative to the internal edge 24c of the groove 24. The outer diameter of the flanges 49b is less than the outer diameter of the tabs 49a and the inner diameter of the internal edge 24c of the groove 24.

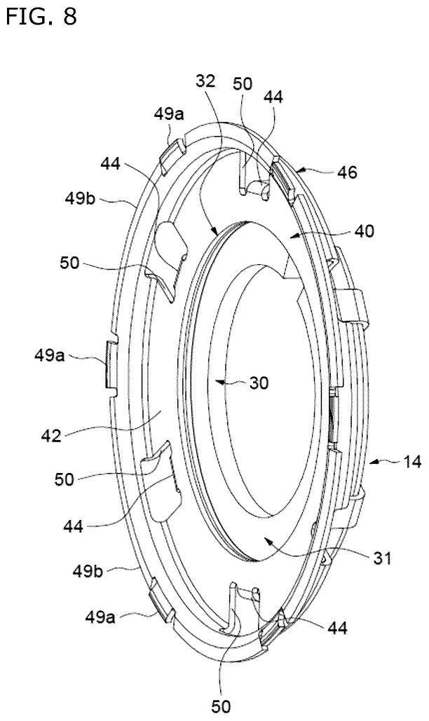

A plurality of through-openings 50 is formed in the thickness of the radial portion 42 and the connecting portion 48 of the mounting plate 40. The openings 50 are formed during the partial cutting of the mounting plate 40 to form the tabs 44. The tabs 44 are formed by the cutting, folding and crimping of the mounting plate 40. The openings 50 are spaced apart from one another in the circumferential direction. Each tab 44 is aligned in the circumferential direction with the associated opening 50. The number of openings 50 corresponds to the number of tabs 44. As shown FIG. 8, the root of each tab 44 extends from an internal edge of the associated opening 50, which are each located on the radial portion 42.

The mounting plate 40 is produced by cutting and stamping. The mounting plate 40 is produced from conductive material, such as for example from aluminum, stainless steel, bronze, copper or other material. Alternatively, the mounting plate 40 may be produced from or formed of electrically non-conductive material with a conductive coating or a conductive paint. Preferably, the mounting plate 40 is produced in a single piece.

To assemble the bearing system 10, the method proceeds in the following manner.

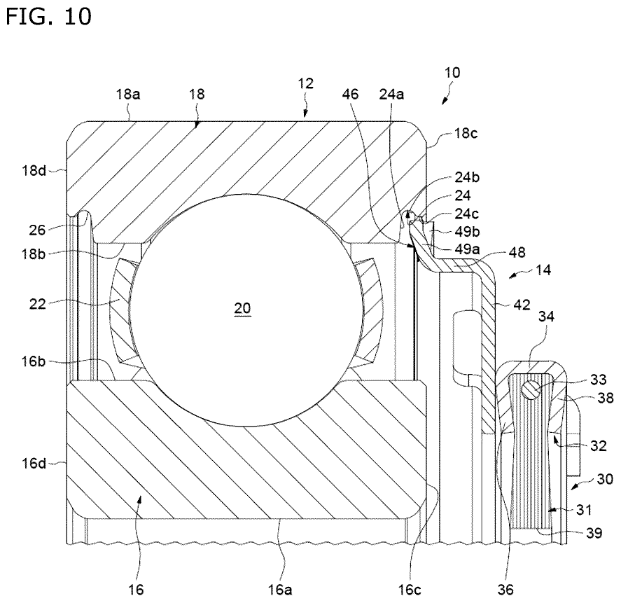

In a first step after manufacturing the grounding brush assembly 14 and before the mounting thereof on the bearing 12, the tabs 49a of the mounting plate are deformed axially by folding on the side opposing the brush 30, as illustrated in FIG. 10. The tabs 49a are folded toward the outer ring 18 of the bearing 12. The tabs 49a extend obliquely toward the outer ring 18. The tabs 49a are folded so that their outer diameter is less than the inner diameter of the internal edge 24c of the groove 24 of the outer ring 18.

Then in a second step, the grounding brush assembly 14 is displaced axially relative to the bearing 12 in order to bring the deformed tabs 49a to bear axially against the first lateral wall 24a of the groove 24 of the outer ring 18. The free ends of the tabs 49a remain radially at a distance from the internal edge 24c of the groove 24 of the outer ring 18 during this relative displacement. In other words, the free ends of the tabs 49a are not brought back into an interference fit with the internal edge 24c of the groove 24.

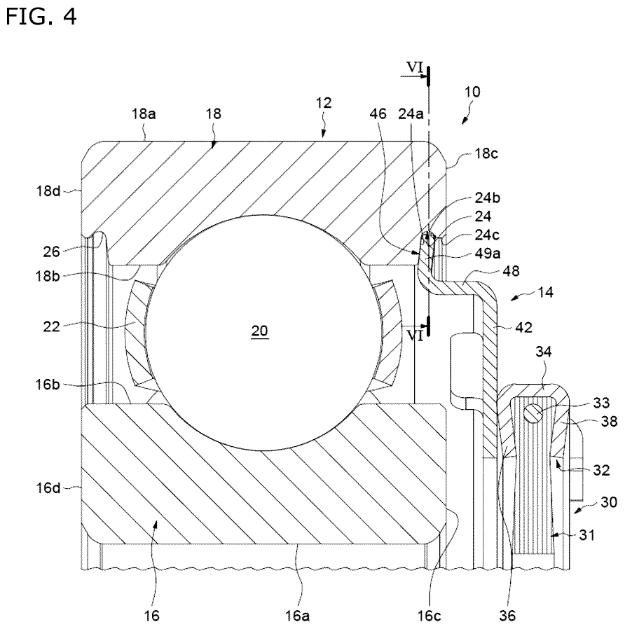

Finally, in a third and final step, an axial force is applied to the tabs 49a so that these tabs 49a are deformed and flattened against the first lateral wall 24a of the groove 24 as illustrated in FIG. 4. After this deformation, the free ends of the tabs 49a are offset radially toward the outside relative to the internal edge 24c of the groove 24 of the outer ring 18. The tabs 49a are thus fixed to the inside of the groove 24 of the outer ring 18.

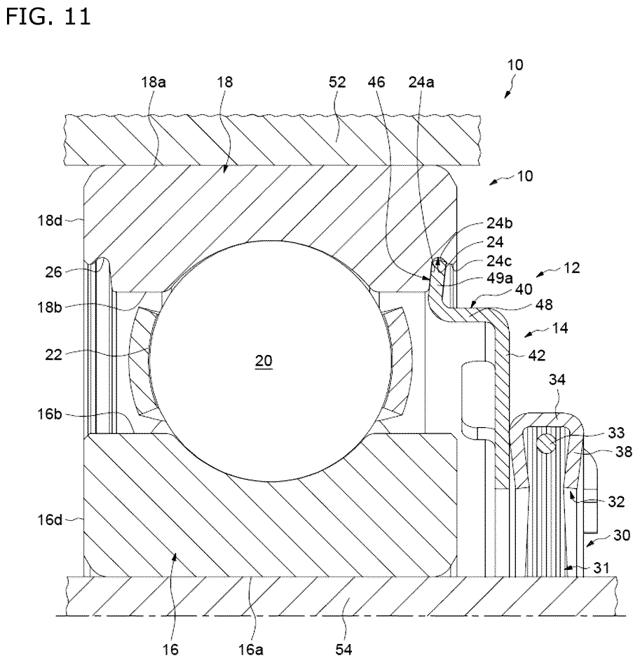

As illustrated in FIG. 11, the brush system 10 can be mounted inside the bore of the housing 52 of the associated electric motor and on the rotating shaft 54 of the motor. The bearing 12 is mounted radially between the bore of the housing 52 and the rotating shaft 54 of the motor.

During the operation of the electric motor, the electric charges which accumulate on the shaft 54 are discharged toward the housing 52 through the conductive fibers 31, the support 32 of the brush 30 and the mounting plate 40 of the assembly 14.

Representative, non-limiting examples of the present invention were described above in detail with reference to the attached drawings. This detailed description is merely intended to teach a person of skill in the art further details for practicing preferred aspects of the present teachings and is not intended to limit the scope of the invention.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter. The invention is not restricted to the above-described embodiments, and may be varied within the scope of the following claims.

We claim:

1. A bearing system comprising:
a bearing including an inner ring and an outer ring, at least one of the inner and outer rings being capable of rotating relative to the other one of the inner and outer rings, the outer ring having a bore and a groove formed within the bore, the groove having first and second axially opposing lateral walls and an internal edge extending between the second lateral wall and a front face of the outer ring; and
a grounding brush assembly including a brush axially offset outwardly relative to the inner ring of the bearing, the brush including a support and a plurality of conductive fibers disposed within the support, and a brush mounting plate secured to the support of the brush and including a mounting portion arranged inside the groove of the outer ring, the mounting portion of the mounting plate having at least one retaining tab axially in abutment on one side against the first lateral wall of the groove and on the other side against the second lateral wall of the groove, a free end of the at least one tab being offset radially outwardly from the internal edge of the groove so as to axially retain the mounting plate relative to the outer ring.

2. The system according to claim 1, wherein the at least one retaining tab of the mounting portion of the mounting plate is flat.

3. The system according to claim 1, wherein the at least one retaining tab of the mounting portion of the mounting plate extends obliquely outwardly.

4. The system according to claim 1, wherein the mounting portion of the mounting plate further includes at least one flange axially in abutment against the first lateral wall of the groove of the outer ring, the at least one flange having a free end that is offset radially inwardly relative to the internal edge of the groove or in contact with the internal edge, the at least one retaining tab being offset circumferentially relative to the at least one flange.

5. The system according to claim 4, wherein a circumferential dimension of the at least one flange is greater than a circumferential dimension of the at least one tab.

6. The system according to claim 4, wherein the at least one flange of the mounting portion of the mounting plate is spaced axially from the second lateral wall of the groove of the outer ring.

7. The system according to claim 4, wherein the mounting portion of the mounting plate includes at least two flanges axially in abutment against the first lateral wall of the groove and at least two retaining tabs, the at least two flanges and the at least two tabs alternating circumferentially about the mounting portion such that one retaining tab is located circumferentially between the two flanges.

8. The system according to claim 1, wherein the mounting plate is formed as a single piece.

9. An electric motor comprising:
a housing;
a shaft; and
at least one bearing system according to claim 1 mounted radially between the housing and the shaft.

10. A method of assembling a bearing system according to claim 1, the method comprising the steps of:
before mounting the grounding brush assembly on the bearing, axially folding the at least one retaining tab of the mounting portion of the mounting plate on a side opposing the brush such that an outer diameter of the mounting plate defined by the at least one retaining tab is less than an inner diameter of the internal edge of the groove of the outer ring of the bearing;
axially displacing the grounding brush assembly relative to the bearing such that the folded retaining tab of the mounting portion of the mounting plate axial abuts against the first lateral wall of the groove of the outer ring of the bearing, a free end of the at least one retaining tab remaining radially at a distance from the internal edge of the groove during axial displacement; and
pressing the at least one retaining tab against the first lateral wall of the groove of the outer ring of the bearing so as the deform the at least one retaining tab such that the free end of the at least one retaining tab is offset radially outwardly relative to the internal edge of the groove.
